(19) United States
(12) Patent Application Publication
(10) Pub. No.: US 2024/0291094 A1
(43) Pub. Date: Aug. 29, 2024

(54) Dividing Wall Assembly for a Battery Housing, Battery and Vehicle

(71) Applicant: Mercedes-Benz Group AG, Stuttgart (DE)

(72) Inventors: Bernd SCHOELLKOPF, Uhingen (DE); Tobias FACKLER, Reichenbach (DE)

(21) Appl. No.: 18/560,889

(22) PCT Filed: Sep. 16, 2022
(86) PCT No.: PCT/EP2022/075792

§ 371 Date: Nov. 14, 2023

(30) Foreign Application Priority Data
Oct. 12, 2021 (DE) 10 2021 005 097.5

(51) Int. Cl. H01M 50/291; H01M 50/249; H01M 50/342; H01M 50/507

(52) U.S. Cl. CPC H01M 50/291; H01M 50/249; H01M 50/3425; H01M 50/507; H01M 2200/20; H01M 2220/20

(57) ABSTRACT

Please substitute the new Abstract submitted herewith for the original Abstract:

A dividing wall assembly for a battery housing. The dividing wall assembly has a dividing wall that lies in a wall plane spanned by a longitudinal direction and a vertical direction orthogonal to the longitudinal direction, at least one conductor rail housing, and at least one conductor rail received in the conductor rail housing. The conductor rail housing is formed as one part with the dividing wall.

### BACKGROUND AND SUMMARY OF THE INVENTION

The invention relates to a dividing wall assembly for a battery housing of the kind defined herein, a battery having a battery housing of the kind defined herein, and a vehicle having such a battery.

Traction batteries for vehicles, referred to as batteries in the following, typically comprise a multi-part housing that surrounds a battery interior, and cell modules arranged in the battery interior that in turn respectively comprise a plurality of galvanic cells. The individual galvanic cells and the cell modules are connected in series and/or in parallel in a particular way to adjust the capacity of the battery and the voltage that can be emitted from the battery.

If a galvanic cell is damaged, the latter can catch fire, whereby neighboring galvanic cells or even the entire cell module can be infected. The flames can spread to the neighboring cell module, which can lead to the entire battery being destroyed. This process is also described as thermal runaway or thermal propagation. To slow down this process, so-called dividing walls are arranged between individual cell modules in the battery interior. Using such a dividing wall, individual cell modules can be thermally and electrically isolated from one another. The risk of flames spreading in the battery interior and cell modules being set on fire due to impermissible heating as a result of the circulation of hot combustion gases can thus be reduced.

To connect cell modules, the arresters of cell modules are connected by means of contact elements, also described as conductor rails. To guide such a conductor rail through a dividing wall, dividing walls usually have openings. These openings also allow gases and/or flames to enter, however, and thus facilitate adjacent cell modules being set on fire. To avoid short-circuits or electric shocks, a conductor rail is arranged in a conductor rail housing, which prevents the conductor rail from being contacted directly.

Batteries further comprise a plurality of different components, such as housing parts, screws, cell modules, conductors, cooling components, power electronics and the like. The production costs for producing a battery are thus correspondingly high.

A battery, a battery module for the battery and a conductor rail for the battery are known from EP 3 282 501 A1. The conductor rail has an integrated protection function. Several galvanic cells can be connected in parallel via the conductor rail, wherein the individual galvanic cells can respectively be connected to the conductor rail via a fuse. The fuse is formed by a metal sheet in which two leg portions are installed, for example by punching. The two leg portions thus form a spring element and enable a relative movement of the galvanic cells with regard to the conductor rail, whereby it is made more difficult for individual galvanic cells to be torn off from the conductor rail. In the event that individual galvanic cells are damaged, the current emitted by a galvanic cell can be rapidly increased, whereby the other galvanic cells connected to the conductor rail can be damaged. In this case, however, the fuse heats up so significantly that it melts, and separates the defective galvanic cells from the conductor rail.

A modular battery system having individually connected cell modules is known from U.S. Pat. No. 5,496,657 A. A dividing wall having cell connectors embedded in the dividing wall is respectively arranged between individual cell modules. Guiding means are connected to the dividing wall, which enable the cell modules to be easily aligned and arranged relative to one another.

A system for mounting electrical energy modules is known from US 2011/0302773 A1. Several cell modules are connected to one another in an electrically conductive manner by one connecting block each and contact elements embedded in the connecting block. An arrangement of the cell modules next to one another or stacked vertically is possible. The connecting block can have a platform-like extension that extends between two cell modules and has a cooling channel for guiding a cooling medium to guide heat out of the cell modules.

An energy storage module having a module housing formed by a composite foil is known from DE 10 2013 202 367 A1. The composite foil respectively surrounds an electric storage cell to form individual receiving pockets. Several receiving pockets are connected to one another by an integrally bonded connection and thus form the energy storage module. Cell connectors for electrically contacting the storage cells are respectively guided through the composite foil on a contact surface between neighboring receiving pockets.

A device for a battery is known from US 2019/0288343 A1. The battery comprises a battery housing having a dividing wall formed by the battery housing itself for sub-dividing a battery interior into several chambers. One cell module is respectively arranged in a respective chamber. Cell connectors are guided through or over the dividing wall to electrically contact the neighboring cell modules.

A battery module and a battery pack is known from DE 10 2017 216 005 A1. Several battery cells are arranged in series and contacted with one another via electrically conductive connecting elements. Support structure bodies are arranged between the battery cells, which allow the battery cells to be easily and reliably aligned with one another and mounted.

EP 3 496 179 A1 further discloses a connector for a battery pack. The battery pack comprises a battery housing having two chambers, wherein a battery module having a plurality of battery cells is arranged in each of the chambers. The chambers are delimited from one another by a wall integrally formed by the battery housing. The wall has an opening through which the connectors are guided to electrically contact the battery modules. The connector itself comprises an electrically conductive core and a sleeve surrounding the core. The sleeve is formed like a dowel to hold the connector fixed in the wall.

The object of the present invention is to disclose an improved dividing wall assembly for a battery housing, using which the production costs of a battery and a cycle time required in manufacture to connect the cell modules are reduced.

A dividing wall assembly for a battery housing comprises a dividing wall that lies in a wall plane spanned by a longitudinal direction and a vertical direction orthogonal to the longitudinal direction and that is equipped to sub-divide a battery interior surrounded by the battery housing into chambers delimited from one another, at least one conductor rail housing and at least one conductor rail received in the conductor rail housing, which is guided through the guiding wall orthogonally to the wall plane. The conductor rail housing is formed as one part with the dividing wall. According to the invention, the dividing wall is formed separately with regard to the battery housing and is equipped to be connected thereto. The dividing wall further has a sandwich structure in an orthogonal direction to the wall plane, wherein a sandwich core comprises a mineral material or consists entirely thereof.

The dividing wall assembly according to the invention allows the number of components required to connect cell modules to be reduced as the conductor rail housing and the dividing wall are formed as one part, which simplifies the production costs for batteries and reduces cycle times in manufacture. The conductor rail can thus be embedded in the dividing wall and the dividing wall can be installed in the battery housing with the conductor rail. It is no longer required to first integrate the conductor rail into a conductor rail housing, to install the dividing wall in the battery housing and then to guide the conductor rail housing with the conductor through the dividing wall. The dividing wall assembly according to the invention additionally has the side-effect that it is made more difficult for neighboring cell modules to infect one another in the event of a thermal runaway of a cell module. The side-effect can be generated by no longer requiring opening gaps between the conductor rail housing and the dividing wall, through which flames and hot gases could otherwise enter.

Several conductor rails can generally also be received by a dividing wall. For example, two conductor rails can protrude through the dividing wall spaced apart from one another in the longitudinal direction. Two, or more than two, cell modules can be contacted via a conductor rail.

For example, a mat made of the mineral material can be embedded in a cavity of the dividing wall. Using the mineral material, the heat resistance of the dividing wall can be orthogonally increased through the wall plane, whereby the heat current transmitted from a cell module on fire to a neighboring cell module is reduced. This further increases the safety of a battery in the event of a fire. The mineral material is further non-conductive, which also increases the safety of the battery in the event of short-circuits.

An advantageous development of the dividing wall assembly provides that the conductor rail in the wall plane abuts at least in a form fit manner on the dividing wall, in particular abuts in a fluid-tight manner. The smaller the gap is between the conductor rail and the dividing wall, the harder it is for flames and gases to jump from a cell module on fire to a neighboring cell module. In particular if the conductor rail abuts on the dividing wall in a fluid-tight manner, no gases can enter between the conductor rail and the dividing wall. The conductor rail can abut directly on the dividing wall or a compensation material is located between the conductor rail and the dividing wall. For example, the conductor rail can be at least partially surrounded by a temperature-resistant heat shrink hose that fills the gap between the conductor rail and the dividing wall in a fluid-tight manner.

Corresponding to a further advantageous embodiment of the dividing wall assembly, the latter comprises a protection cap arrangement for each conductor rail, wherein the protection cap arrangement together with the dividing wall encloses a respective conductor rail, and the protection cap arrangement has a spacer lying in the wall plane and arranged on the protection cap arrangement in the vertical direction, wherein the spacer and an end face of the dividing wall lying in the vertical direction abut flush on each other in the vertical direction. By providing a protection cap arrangement, the number of parts of the dividing wall assembly increases, but this is still lower than conductor rail housings used previously, as these too are usually provided with protection caps. Providing a protection cap arrangement allows bent conductor rails to be arranged in the dividing wall. To introduce such a conductor rail, for example bent in a U shape, the dividing wall can have an intake opened in the vertical direction on the end face. By means of the U shape, positional tolerances and thermal expansion of the conductor rails can be compensated for. Using the protection cap arrangement, the intake can be closed to reduce the entry of gases through the dividing wall to a minimum or even to prevent it entirely. Using the spacer, gaps between the dividing wall and the battery housing can be bridged or closed, which improves the isolating effect of the dividing wall assembly. The protection cap arrangement can, for example, have a protection cap carrier having the corresponding spacer and two protection caps. The spacer can be formed as one part with the protection cap carrier, be moulded thereon or be connected thereto in another way, for example by means of an adhesive connection or screws.

A further advantageous embodiment of the dividing wall assembly further provides that the dividing wall comprises at least one non-conductive material, in particular plastic and/or a fiber plastic composite material, and the dividing wall is preferably produced by injection moulding. Plastic is a comparatively cheap non-conductive material. The mechanical properties of the dividing wall can in particular be improved by a design as a fiber plastic composite. Thus, for example, the stability and stiffness of the dividing wall can be increased. Using plastic or a fiber plastic composite material allows manufacture by means of injection moulding, whereby the dividing wall, even in high quantities, can be produced particularly cheaply and in a time-efficient manner. For example, the dividing wall comprises PA6, GF35, a thermoset and/or a so-called sheet moulding compound (SMC).

A further advantageous embodiment of the dividing wall assembly further provides that a tolerance compensation mat, which is in particular continuous over the entire length of the dividing wall in the longitudinal direction, is arranged on an end face of the dividing wall lying in the vertical direction, wherein the tolerance compensation mat runs over the conductor rail when viewed in the vertical direction. Using the tolerance compensation mat, position tolerances between the dividing wall arranged in the battery housing and the battery housing can be compensated for, and potential gaps can thus be closed. This makes it more difficult for flames to jump over and/or for gases to spread in the battery interior. The tolerance compensation mat can extend over the entire length of the dividing wall or abut only partially on the end face of the dividing wall. It is also possible that the tolerance compensation mat is sub-divided into several portions, for example two, three or four portions. Thus, points are particularly omitted at which the battery housing abuts directly on the end face of the dividing wall. The tolerance compensation mat can, for example, be adhered to the dividing wall for fixing. The tolerance compensation mat comprises a plastic foam, rubber, silicone or the like, for example.

According to the invention, a battery having a battery interior surrounded by a battery housing comprises at least one dividing wall assembly previously described arranged in the battery housing. Due to the reduced number of parts of the dividing wall assembly according to the invention in relation to the provision of a separate dividing wall and a conductor rail surrounded by a separate conductor rail housing, cycle times in the manufacture of the battery according to the invention can be reduced and the battery can thus be manufactured particularly quickly and in a cost-efficient manner.

An advantageous development of the battery provides that the battery comprises at least two cell modules arranged in the battery interior, wherein the dividing wall assembly is arranged between the two cell modules, such that the dividing wall assembly sub-divides the battery interior into two chambers delimited from one another, in particular two chambers hermetically delimited from one another, wherein the two cell modules are in electrically conductive contact with each other via the conductor rail. The dividing wall assembly according to the invention not only allows the manufacture time of the battery to be reduced, but also increases the battery's fire protection. The cell modules arranged in the battery interior can thus be delimited from one another with the dividing wall assembly according to the invention, wherein potential gaps can be reduced or even completely closed, in particular in a fluid-tight manner, in comparison with previously used dividing walls and conductor rail housings, which makes it impossible, or at least harder, for flames to jump over and for hot gases to cross over from a cell module that is thermally overrunning to a neighboring cell module.

The battery housing preferably has at least one pressure relief valve for each chamber. For example, such a pressure relief valve can be formed by a rupture disk. If one of the cell modules thermally overruns, gases exiting from the cell module can lead to an increase in pressure in the corresponding chamber in which the respective cell module is arranged. The danger thus arises that individual chambers or even the battery housing itself can burst. By providing a pressure relief valve, pressure can be compensated, and thus the chambers and/or the battery housing can be prevented from bursting. Using the dividing wall assembly according to the invention, individual chambers can be hermetically delimited from one another, which makes it necessary to provide at least one pressure relief valve for each chamber to further protect each chamber from an impermissible internal pressure. The dividing wall assembly and the battery housing are formed such that sufficient volume remains in each chamber to guide gases exiting a cell module in the direction of a respective pressure relief valve in a targeted manner. Individual chambers without a pressure relief valve can also be provided, which neighbor at least one chamber provided with the pressure relief valve in a fluid-conducting manner. If a cell module arranged in a chamber without a pressure relief valve thermally overruns, gases or steam exiting the cell module can also exit the battery housing via the pressure relief valve of the neighboring chamber.

According to the invention, the vehicle comprises a battery previously described. The vehicle can be any vehicle, such as a passenger car, HGV, truck, bus or the like. The vehicle can be driven purely by an electric battery or alternatively formed as a hybrid vehicle, in particular as a plugin hybrid. In the event that the battery catches fire, vehicle occupants have more time to get to safety due to the improved fire protection of the battery according to the invention. It is additionally made more difficult for neighboring cell modules to be infected, whereby more time is available to introduce extinguishing measures.

Further advantageous embodiments of the dividing wall assembly according to the invention and of the battery according to the invention result from the exemplary embodiments, which are described in more detail in the following with reference to the figures.

### BRIEF DESCRIPTION OF THE DRAWINGS

FIG. 1 shows an exploded depiction of a battery having a dividing wall assembly known from the prior art;

FIG. 2 shows a sectional view through the battery from FIG. 1 in an installation position of a conductor rail;

FIG. 3 shows a perspective depiction of a dividing wall assembly according to the invention according to a first embodiment;

FIG. 4 shows an exploded depiction of a dividing wall assembly according to the invention according to an alternative embodiment; and

FIG. 5 shows a sectional view through a battery having the dividing wall assembly according to the invention in the installation position of the conductor rail.

### DETAILED DESCRIPTION OF THE DRAWINGS

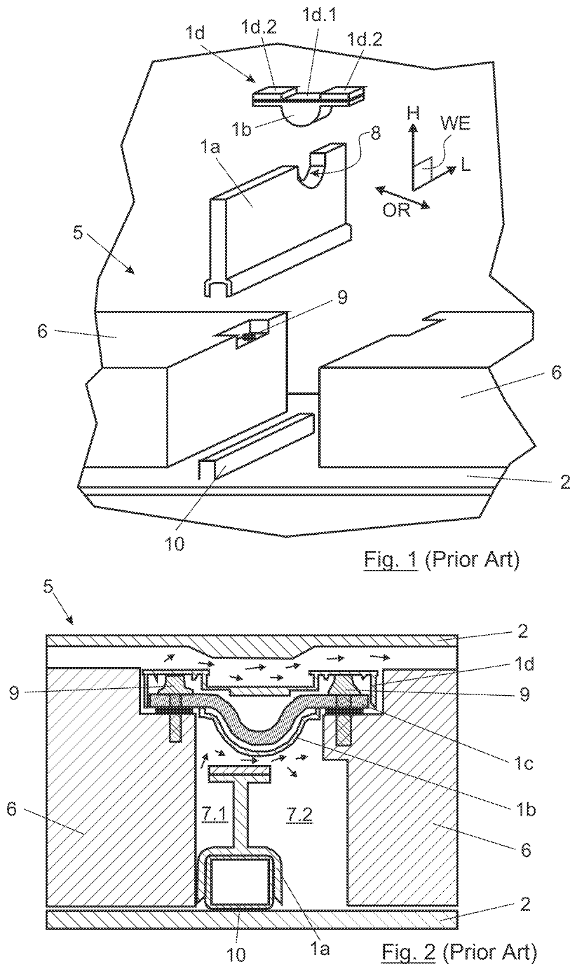

FIG. 1 shows the installation situation of a dividing wall 1a known from the prior art in a battery 5, for example a traction battery for vehicles. For the sake of providing an overview, only the lower part of the battery housing 2 is depicted in FIG. 1. In a battery interior surrounded by the battery housing 2, at least two cell modules 6 are arranged, which are delimited from one another by means of the dividing wall 1a. The dividing wall 1a extends in a wall plane WE spanned through a longitudinal direction L and a vertical direction H orthogonal to the longitudinal direction L between the cell modules 6 and sub-divides the battery interior surrounded by the battery housing 2 into two chambers 7.1 and 7.2 depicted in FIG. 2. At least one cell module 6 is correspondingly arranged in one of the chambers 7.1 and 7.2. The separating wall 1a is, for example, connected in a form fit manner to a frame profile 10 protruding from the battery housing 2.

Using the dividing wall 1a, it is made more difficult for flames and/or hot gases to spread between the two chambers 7.1 and 7.2. An aperture 8 is made in the dividing wall 1a, through which a conductor rail 1c is guided in an orthogonal direction OR through the wall plane WE to contact the two cell modules 6. The conductor rail comprises an electrically conductive material, for example copper. The conductor rail 1c has openings, for example through holes, through which the screws 9 are guided to fix the conductor rail 1c to the two cell modules 6. The conductor rail 1c is surrounded by a conductor rail housing 1b to prevent undesirable contact of a component or a person with the conductor rail 1c from leading to a short-circuit. The conductor rail housing 1b is provided with a protection cap arrangement 1d upwards in the vertical direction H, the protection cap arrangement comprising a protection cap carrier 1d.1 and two protection caps 1.d2. The protection caps 1.d2 can be opened to enable the conductor rail 1c to be screwed to the cell modules 6.

Mounting the battery is complex due to the comparatively large number of parts to be installed. It is further possible that, if at least one cell module 6 is on fire, flames and/or hot gases exiting the cell module 6 jump or cross over via the aperture 8 through the dividing wall 1a, and thus for example from the first chamber 7.1 to the second chamber 7.2. This increases the risk that the neighboring cell module 6 is also ignited or at least damaged.

FIG. 2 shows the installation situation of the dividing wall 1a and the conductor rail 1c with the conductor rail housing 1d depicted in FIG. 1 again in a sectional view through the installation position of the conductor rail 1c in the longitudinal direction L. Several arrows are drawn in FIG. 2, which symbolize the entry of gas and/or flames from the first chamber 7.2 into the second chamber 7.2 via the opening lying between the dividing wall 1a and the conductor rail housing 1b.

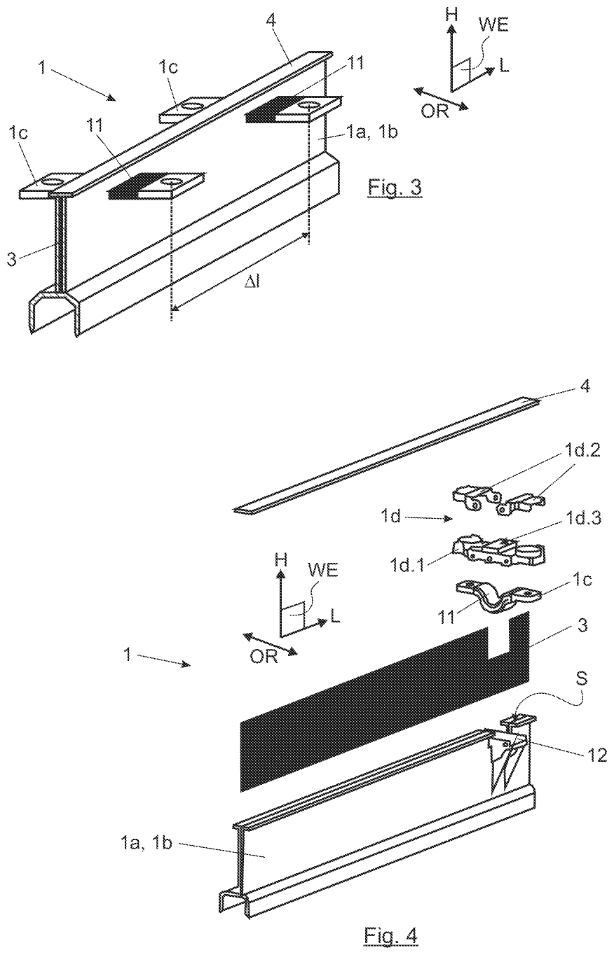

FIG. 3 shows a perspective depiction of a dividing wall assembly 1 according to the invention. The dividing wall 1a and the conductor rail housing 1b are here formed as one part. It is thus possible to reduce the number of parts to be installed in the manufacture of the battery 5. The cycle times in manufacture can thus be reduced, which leads to cost savings.

A further positive side-effect of the dividing wall assembly 1 according to the invention enables the open surface of the aperture 8 to be reduced to a minimum level or to close other gaps between the dividing wall 1a and the battery housing 2. In a particularly preferred embodiment, it is possible to hermetically delimit the two chambers 7.1 and 7.2 from one another with a dividing wall assembly 1 according to the invention, whereby a particularly high resistance to flames jumping over or gases crossing over from the first chamber 7.1 to the second chamber 7.2 is achieved.

The dividing wall assembly 1 according to the invention can have one or several conductor rails 1c. The dividing wall 1a thus forms the conductor rail housing 1b for one or several conductor rails 1c. For example, the dividing wall assembly 1, as depicted in FIG. 3, has two conductor rails 1c. The latter are spaced apart from one another in the longitudinal direction L at a spacing Δl from one another. The dividing wall 1a correspondingly has two openings for receiving and guiding through conductor rails 1c in the form of boards or bands in the orthogonal direction OR. The conductor rails 1c can abut directly or indirectly on the dividing wall 1a. For example, the conductor rails 1c can be at least partially surrounded by a heat shrink hose 11. Using the heat shrink hose 11, a possible gap between the dividing wall 1a and the conductor rail 1c can be closed in a fluid-tight manner. A tolerance compensation mat 4 can further be arranged on the dividing wall 1a in the vertical direction H, which will be discussed in more detail later.

FIG. 4 shows an advantageous embodiment of the dividing wall assembly 1 according to the invention, which also enables the intake of bent conductor rails 1c, as shown in FIGS. 1, 2, 4 and 5. Such a conductor rail 1c has a substantially U-shaped profile having two extensions lying in a plane for contacting the conductor rail 1c with the cell modules 6. Using this movement, relative movements between the cell modules 6 and thermal expansion can, for example, be compensated for. In the exemplary embodiment of the dividing wall assembly 1 shown in FIG. 4, the conductor rail 1c to be received is introduced through the dividing wall 1a when viewed in the vertical direction H into the receiving chamber 12 embedded in the dividing wall 1a, and the receiving chamber 12 is closed with the protection cap arrangement 1d. Here too, the protection cap arrangement 1d comprises the protection cap carrier 1d.1 and two protection caps 1d.2. The conductor rail 1c preferably abuts indirectly on the dividing wall 1a and the protection cap arrangement 1d in the wall plane WE in a fluid-tight manner via the heat shrink hose 11.

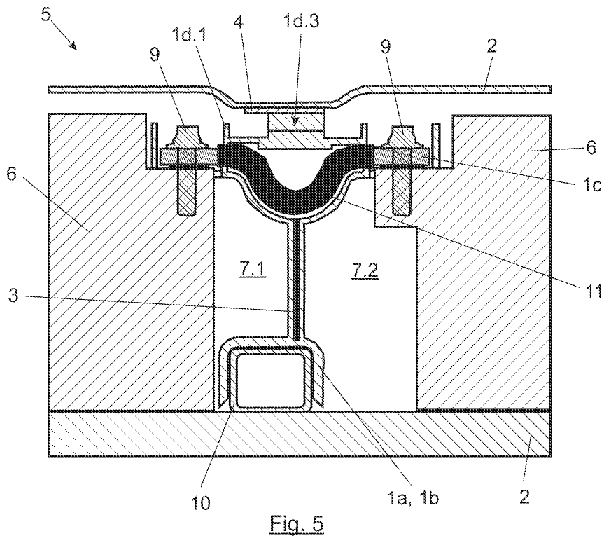

To compensate a distance between the upper end or side of the protection cap arrangement 1d when viewed in the vertical direction H and an end face S of the dividing wall 1a, the protection cap arrangement 1d has a spacer 1d.3 according to the invention. The spacer 1d.3 fills the remaining cavity between the protection cap carrier 1d.1 and the battery housing 2, which can be seen again in FIG. 5. In particular, the spacer 1d.3 has such an extension in the vertical direction H that the spacer 1d.3 is connected flush to the end face S of the dividing wall 1a when viewed in the vertical direction H.

A tolerance compensation mat 4 is thus particularly preferably arranged on the end face S of the dividing wall 1a in the longitudinal direction L over the complete length of the dividing wall 1a. The tolerance compensation mat 4 comprises a plastic foam, rubber, silicone or the like, for example, and promotes the hermetic delimiting of the two chambers 7.1 and 7.2 from one another. Possible gaps between the battery housing 2 and the dividing wall 1a or the spacer 1d.3 can be closed with the tolerance compensation mat 4.

The dividing wall 1a has a sandwich construction when viewed in the orthogonal direction OR, wherein a sandwich core 3 is embedded into a cavity of the dividing wall 1a. The sandwich core 3 comprises a mineral material or consists entirely thereof. A mineral material has the advantage that it does not conduct current and additionally increases heat resistance in the orthogonal direction OR through the dividing wall 1a. The risk of component damage with a thermal cause for two neighboring cell modules 6 can thus be reduced during thermal runaway of one of the cell modules 6. The dividing wall 1a and the protection cap arrangement 1d also preferably comprise a non-electrically conductive material, for example plastic. PA6, GF35, any thermoset or a so-called sheet moulding compound, and thus a fiber plastic compound material, can be the plastic, for example. The dividing wall 1a and the protection cap arrangement 1d can preferably be produced by means of injection moulding, which allows the corresponding components to be manufactured particularly quickly and in a cost-efficient manner.

To fix the protection cap arrangement 1d to the dividing wall 1a, the protection cap arrangement 1d can, for example, be clipped onto the dividing wall 1a.

FIG. 5 shows the embodiment of the dividing wall assembly 1 according to the invention again in a section at the height of the installation position of the conductor rail 1c in the longitudinal direction L. A comparison of FIG. 5 and FIG. 2 shows that free openings or gaps between the dividing wall 1a and the battery housing 2 and between the conductor rail 1c and the dividing wall 1a or the protection cap arrangement 1d have been closed, such that possible flames and/or gases cannot spread over the chambers 7.1 and 7.2. In FIG. 5, the protection caps 1d.2 are not depicted.

To prevent one of the chambers 7.1, 7.2 from bursting in the event of the thermal runaway of a cell module 6, the battery housing 2 can preferably have at least one pressure relief valve (not depicted) for each chamber 7.1, 7.2. Such a pressure relief valve can, for example, be a rupture disc.

1.-9. (canceled)

10. A dividing wall assembly (1) for a battery housing (2), comprising:
a dividing wall (1a) that lies in a wall plane (WE) spanned by a longitudinal direction (L) and a vertical direction (H) which is orthogonal to the longitudinal direction (L), wherein a battery interior surrounded by the battery housing (2) is sub-dividable by the dividing wall (1a) into chambers (7.1, 7.2) delimited from one another;
a conductor rail housing (1b); and
a conductor rail (1c) received in the conductor rail housing (1b) which is guided through the dividing wall (1a) orthogonally to the wall plane (WE), wherein the conductor rail housing (1b) is formed as one part with the dividing wall (1a);
wherein the dividing wall (1a) is formed separately from the battery housing (2) and is attachable to the battery housing (2);
wherein the dividing wall (1a) has a sandwich structure in an orthogonal direction (OR) to the wall plane (WE) and wherein a sandwich core (3) of the sandwich structure includes a mineral material or consists entirely of the mineral material.

11. The dividing wall assembly (1) according to claim 10, wherein the conductor rail (1c) abuts at least indirectly in a form fit manner on the dividing wall (1a) in the wall plane (WE).

12. The dividing wall assembly (1) according to claim 10, further comprising a protection cap arrangement (1d) for the conductor rail (1c) and a spacer (1d.3), wherein the protection cap arrangement (1d) together with the dividing wall (1a) encloses the conductor rail (1c), wherein the spacer (1d.3) lies in the wall plane (WE) and is disposed on the protection cap arrangement (1d) in the vertical direction (H), and wherein the spacer (1d.3) and an end face (S) of the dividing wall (1a) lying in the vertical direction (H) abut flush on each other in the vertical direction (H).

13. The dividing wall assembly (1) according to claim 10, wherein the dividing wall (1a) comprises at least one non-conductive material and/or a fiber plastic composite material and wherein the dividing wall (1a) is an injection moulded part.

14. The dividing wall assembly (1) according to claim 10, further comprising a tolerance compensation mat (4) that is continuous over an entire length of the dividing wall (1a) in the longitudinal direction (L) and is disposed on an end face (S) of the dividing wall (1a) lying in the vertical direction (H), wherein the tolerance compensation mat (4) runs over the conductor rail (1c) when viewed in the vertical direction (H).

15. A battery (5), comprising:
a battery interior surrounded by a battery housing (2); and
the dividing wall assembly (1) according to claim 10 disposed in the battery interior.

16. The battery (5) according to claim 15, further comprising two cell modules (6) disposed in the battery interior, wherein the dividing wall assembly (1) is disposed between the two cell modules (6) such that the dividing wall assembly (1) sub-divides the battery interior into two chambers (7.1, 7.2) hermetically delimited from one another and wherein the two cell modules (6) are in electrically conductive contact with each other via the conductor rail (1c).

17. The battery (5) according to claim 16, wherein the battery housing (2) has a respective pressure relief valve for each of the two chambers (7.1, 7.2).

18. A vehicle, comprising:
a battery (5), wherein the battery (5) includes:
a battery interior surrounded by a battery housing (2); and
the dividing wall assembly (1) according to claim 10 disposed in the battery interior.
